(19) United States
(12) Patent Application Publication
(10) Pub. No.: US 2026/0172308 A1
(43) Pub. Date: Jun. 18, 2026

(54) CLOUD-BASED DYNAMIC TELEMETRY COLLECTION FOR SOFTWARE-DEFINED WIDE AREA NETWORK (SD-WAN) FABRICS

(71) Applicant: Cisco Technology, Inc., San Jose, CA (US)

(72) Inventors: Bhairav Dutia, Santa Clara, CA (US); Sanjeev Pandurang Tondale, Fremont, CA (US); Aarthi Gujjar, San Jose, CA (US)

(21) Appl. No.: 19/066,824

(22) Filed: Feb. 28, 2025

Related U.S. Application Data
(60) Provisional application No. 63/733,693, filed on Dec. 13, 2024.

(51) Int. Cl. H04L 41/083; H04L 43/10

(52) U.S. Cl. CPC H04L 41/083; H04L 43/10

(57) ABSTRACT

Techniques for improving telemetry data collection using a telemetry engine with dynamic updating and processing of a telemetry rule set are described. The method includes collecting cloud-based dynamic telemetry data for software-defined wide area network Software-Defined Wide Area Network (SD-WAN) fabrics and configuring one or more rules for data collection in correspondence with at least one data type of a plurality of data types being collected. The telemetry engine can make changes in a management plane to retrieve one or more rules to enable a request for data collection about network devices based on collected data from one or more data sources. Also, updates can be made based on one or more rules in the management plane that enable the telemetry engine to make requests for data collection without changes to network software, thereby enabling a faster data collection process while preserving privacy in the data collection about customer data.

### RELATED APPLICATION

The present U.S. Non-provisional Patent Application claims the priority benefit of a first prior-filed U.S. Provisional Patent Application having the title “CLOUD-BASED DYNAMIC TELEMETRY COLLECTION FOR SD-WAN FABRICS,” Ser. No. 63/733,693 filed Dec. 13, 2024. The entire content of the identified earlier-filed U.S. Provisional Patent Application is hereby incorporated by reference into the present patent application.

### TECHNICAL FIELD

The present disclosure generally relates to techniques for collecting cloud-based dynamic telemetry for software-defined wide area network (SD-WAN) fabrics, providing an enhanced means for telemetry collection in SD-WAN dynamically rather than statically.

### BACKGROUND

In contrast to traditional static monitoring approaches, dynamic telemetry is an event-driven or periodically configured mechanism that gathers and delivers network performance data in near real-time. Rather than waiting for the next interval, telemetry sources (such as edge devices, controllers, or gateway nodes) stream relevant metrics to centralized collectors or analytics platforms automatically.

SD-WAN solutions typically rely on a cloud-delivered control plane, which orchestrates configurations and policies across geographically distributed sites. This same cloud-native architecture can be leveraged to collect, store, and analyze telemetry data from all SD-WAN endpoints.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a schematic view of an example architecture that may be used to perform some of the techniques described herein for utilizing the telemetry engine for data collection in an SDWAN, according to some examples.

FIG. 2 collectively illustrates an example rule set for the SDWAN data collection of the telemetry system shown in FIG. 1 according to some examples.

FIG. 3 shows the method of a rule-based telemetry flow diagram associated with some of the various technologies described herein.

FIG. 4 illustrates a flow diagram of an example method associated with data collection by the telemetry engine routing control-plane traffic and data-plane traffic associated with a common application.

FIG. 5 is a computing system diagram illustrating an example configuration of a data center that can be utilized to implement aspects of the technologies disclosed herein.

FIG. 6 illustrates a schematic view of an example computer hardware architecture for implementing a telemetry engine in a management plane with a controller that can be utilized to implement aspects of the various technologies presented herein.

### DESCRIPTION OF EXAMPLE EMBODIMENTS

### Overview

This disclosure relates to a method for collecting cloud-based dynamic telemetry for Software-Defined Wide Area Network (SD-WAN) fabrics, providing an enhanced means for telemetry collection in SD-WAN dynamically rather than statically. The dynamic telemetry collection method and system allow for faster decision-making, notification of security issues, and customization of collected information.

In some examples, systems and methods are provided for collecting telemetry data in an SDWAN using a telemetry engine. The telemetry engine provides a dynamic means for data collection while eliminating or not requiring upgrades to a controller or network device for the data collection. In some examples, the telemetry engine, which is a rule-based engine, may be independently configured and request new metric types of data for collection from the network without having to make any changes to network controllers or devices when making new metric data requests. In some examples, the telemetry rule-based engine may be configured in a management plane with network controllers to provide dynamic rule sets for data collection rather than having static-based data requests.

In some examples, the telemetry engine will be configured to process multiple types of rules on demand by downloading a rule set or one or more rules from a catalyst or network cloud. By way of example, and not limitation, a method according to the various techniques described in this disclosure may include configuring one or more rules for data collection in correspondence with at least one data type of a plurality of data types being collected and configuring a telemetry engine in a management plane to retrieve one or more rules to enable a request for data collection about network devices based on collected data from one or more data sources.

In some examples, methods and systems are provided for updating one or more rules in the management plane that enable the telemetry engine to make requests for data collection without changes to network software, thereby enabling a faster data collection process while preserving privacy in the data collection about network devices.

In some examples, the techniques described herein relate to a method including collecting cloud-based dynamic telemetry data for software-defined wide area network Software-Defined Wide Area Network (SD-WAN) fabrics, configuring one or more rules for data collection in correspondence with at least one data type of a plurality of data types being collected; configuring a telemetry engine in a management plane to retrieve one or more rules to enable a request for data collection about network devices based on collected data from one or more data sources and updating the one or more rules in the management plane that enable the telemetry engine to make requests for data collection without changes to network software, thereby enabling a faster data collection process while preserving privacy in the data collection about network devices.

In some examples, the techniques described herein relate to a method, further including configuring the telemetry engine to retrieve one or more rules for data collection from a network cloud wherein one or more rules have been independently configured for the data collection.

In some examples, the techniques described herein relate to a method, further including configuring the telemetry engine to download one or more rules on demand from the SDWAN fabric to generate telemetry data for exporting to other data collection devices.

In some examples, the techniques described herein relate to a method, further including configuring the telemetry engine in the management plane to query an appropriate database to generate telemetry data.

In some examples, the techniques described herein relate to a method wherein the telemetry engine is configured to query the appropriate database on demand based on data contained in one or more rules.

In some examples, the techniques described herein relate to a method, further including configuring a controller in operable communication with the telemetry engine to download one or more rules discoverable at the telemetry engine on demand or periodically for processing one or requests associated with the one or more rules by the controller.

In some examples, the techniques described herein relate to a method, further including configuring the telemetry engine in the management plane for changing to a new metric associated with data collection without making network device changes for data collection based on the new metric.

In some examples, the techniques described herein relate to a method, further including configuring the telemetry engine in the management plane to change at least one of the frequency of data collection or a type of data being collected.

In some examples, the techniques described herein relate to a method, further including configuring the telemetry engine in the management plane to receive updates of one or more rules that have been independently updated by third parties in operable communication via a network cloud.

In some examples, the techniques described herein relate to a system including: one or more processors; and one or more non-transitory computer-readable media storing instructions that, when executed by the one or more processors, cause the system to perform operations including: collecting cloud-based dynamic telemetry data for software-defined wide area network Software-Defined Wide Area Network (SDWAN) fabrics; configuring one or more rules for data collection in correspondence with at least one data type of a plurality of data types being collected; configuring a telemetry engine in a management plane to retrieve one or more rules to enable a request for data collection about network devices based on collected data from one or more data sources; and updating the one or more rules in the management plane that enable the telemetry engine to make requests for data collection without changes to a network software thereby enabling a faster data collection process while preserving privacy in the data collection about network devices.

In some examples, the techniques described herein relate to one or more non-transitory computer-readable media storing instructions that, when executed by one or more processors, cause the one or more processors to perform operations including: collecting cloud-based dynamic telemetry data for software-defined wide area network Software-Defined Wide Area Network (SDWAN) fabrics; configuring one or more rules for data collection in correspondence with at least one data type of a plurality of data types being collected; configuring a telemetry engine in a management plane to retrieve one or more rules to enable a request for data collection about network devices based on collected data from one or more data sources; and updating the one or more rules in the management plane that enable the telemetry engine to make requests for data collection without changes to a network software thereby enabling a faster data collection process while preserving privacy in the data collection about network devices.

In some examples, the techniques described herein relate to one or more non-transitory computer-readable media; the operations further include configuring the telemetry engine to retrieve one or more rules for data collection from a network cloud wherein the one or more rules have been independently configured for the data collection wherein the telemetry engine is configured to query an appropriate database on demand based on data contained in one or more rules.

Additionally, the techniques described herein may be performed as a method and/or by a system having non-transitory computer-readable media storing computer-executable instructions that, when executed by one or more processors, perform the techniques described herein.

### EXAMPLE EMBODIMENTS

A cloud-based dynamic telemetry system for SD-WAN continuously collects, transmits, and analyzes data from controllers—such as routers, firewalls, and software agents—enabling near-real-time visibility and control of network performance and security. Rather than relying on periodic polling or batch uploads, the system makes requests using a set of rules that are independently configured to collect telemetry data from various controllers in a network fabric (including metrics like latency, jitter, packet loss, bandwidth usage, and application performance) to a centralized cloud management platform. The platform aggregates information gathered from controllers that are coupled to potentially thousands of endpoints. In some examples, the SD-WAN controller may automatically adjust routing paths, QoS policies, and security settings, ensuring that traffic takes the most efficient, secure paths based on collected data from rules that indicate current network conditions.

Accordingly, described herein are techniques for an enhanced means of telemetry collection in an SD-WAN that is dynamic rather than static. In some examples, dynamic telemetry collection methods and systems are provided that allow for faster decision-making, notification of security issues, and customization of collected information. The telemetry data collection methods and systems can be configured to change the frequency of data collection, and also for the types of information collected. External entities can trigger dynamic changes in data collection based on their specific needs.

In some examples, telemetry refers to the data or metrics network devices and software send to a central management system for various operational purposes. In an example, the CISCO® vManage, is a CISCO® SD-WAN Manager that may be used to configure, monitor, and administer the CISCO® SD-WAN environment. In some examples, CLIs Command-Line Interfaces (CLIs) are commands within network device configurations that indicate particular features or functionalities. A controller upgrade is any software update or patch that a controller such as the CISCO® vManage requires to introduce new functionalities or resolve issues.

The static mechanisms used in telemetry apply determinations through two primary methods: scanning running device configurations for particular CLIs and checking the controller's internal database for specific attributes. For instance, if certain CLIs—labeled A, B, and C—are present, the controller concludes that Feature X is enabled and includes it in telemetry outputs. Similarly, if database attributes—labeled X, Y, and Z—are found, Feature A is assumed to be in use, and corresponding telemetry data is reported. Because the telemetry mechanism hinges on detecting predefined CLIs and attributes, any addition, removal, or adjustment of those references entails revising the controllers'internal logic. This means updates to the telemetry framework require a code change or configuration update, making the process less flexible and more time-consuming. Also, to track new features or modify telemetry definitions, administrators must perform a controller upgrade, which can delay critical business decisions and introduce operational complexities. Upgrades also risk potential downtime and version compatibility issues. Furthermore, the reliance on static mappings means limited feature visibility, mainly if new features appear between releases. As these static mappings grow in volume, the process of maintaining them becomes increasingly complex and error-prone, impeding scalability.

Because changes cannot be applied without a complete controller upgrade, business decisions reliant on accurate telemetry can be delayed, undermining strategic planning, capacity management, and feature adoption assessments. On the security and compliance front, the inability to quickly gather additional data may hinder real-time threat detection or comprehensive compliance reporting, exposing organizations to risks.

In some examples, a controller's telemetry collection mechanism may be constrained by its reliance on static definitions tied to particular CLIs and database attributes. There is a need for a controller upgrade to incorporate new telemetry logic so as not to hinder its ability to respond swiftly to an ever-changing set of requirements and challenges. Addressing this rigidity is crucial for ensuring that a controller's data collection solutions remain agile, secure, and fully capable of meeting evolving business, security, and compliance needs.

In some examples, systems and methods are provided that enable telemetry data collection by linking to and collecting data from different databases for configuring a set of rules for data collection in the management plane and for saving the collected data in files. In some examples, a telemetry engine is configured to retrieve rules from the cloud or other external sources that the user independently configures. The telemetry engine process and system uses a set of rules to collect data from one or more sources. In some embodiments, the user-configured rules may be written in simplistic JSON scripts, stored remotely in the cloud, and downloaded by the telemetry engine in a management plane for execution. The telemetry engine enables dynamic rule updates without requiring changes to the network software, resulting in faster collection and preserved privacy.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments as described herein like numbers refer to like elements throughout.

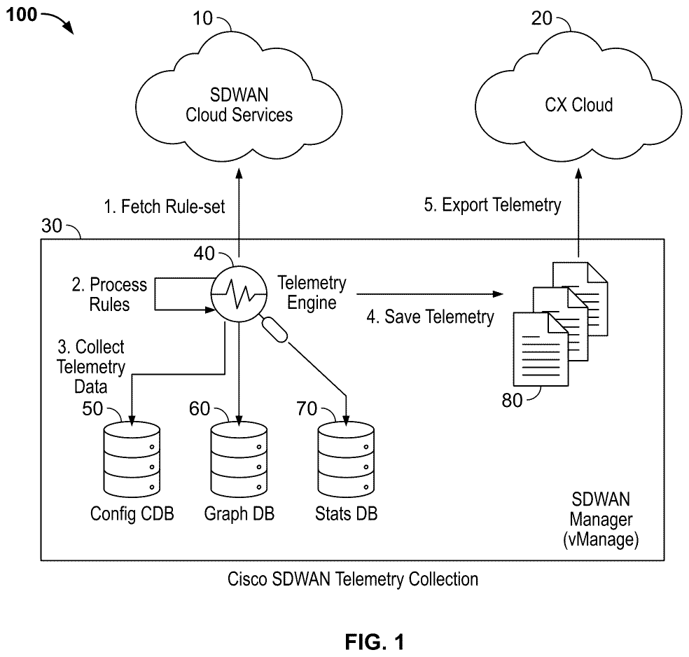

FIG. 1 illustrates a schematic view of an example architecture 100 that may be used to perform some of the techniques described herein for utilizing the telemetry engine for data collection in an SDWAN, according to some examples.

The example architecture 100 in FIG. 1 shows a telemetry collection system that is dynamic by eliminating the need for controller or device upgrades for collecting new metrics. This is achieved by introducing a new ‘telemetry (rule) engine’ (telemetry engine 40) in the controllers (SDWAN manager 30) and pairing it with the Catalyst SDWAN cloud 20. In some examples, the telemetry engine 40 will be able to process any rule on demand by downloading a rule set from the Catalyst SDWAN cloud 20 (SSP-Self-service portal). In some examples, the SDWAN manager 30 (e.g., vManage) is connected to the Catalyst SDWAN cloud 20 to be able to download these rule sets periodically. The telemetry engine 40 is configured to then, upon downloading rule sets, process the rule sets and generate telemetry data, which can be exported out. For example, a CISCO® vManage controller can dynamically update the rule sets as needed or required without having to upgrade the controllers.

In some examples, the Catalyst (CX) cloud 20 or the SDWAN cloud services 10, the networked environments may include devices that are housed or located in one or more data centers that may be located at different physical locations. For instance, the networked environment may be supported by networks of devices in a public cloud computing platform, a private/enterprise computing platform, and/or any combination thereof.

The example architecture 100 in FIG. 1 comprises the SDWAN network cloud services 10 providing multi-vendor cloud services connected to a management plane that may include an SDWAN manager 30 (e.g., the vManage). In FIG. 1, the customer experience cloud (CX cloud 20) coupled with the SDWAN manager 30 enables the seamless delivery of multi-vendor applications (e.g., multi-stack applications) and various user experience data observed across connectivity, computing, storage, and security that may be integrated with the deployment, orchestration, and behavior of multiple vendor applications and microservices. The SDWAN manager 30 is configured to include the component of the telemetry engine 40 that is connected to one or more databases or data centers. In instances, the connected databases may consist of a configuration database 50, a graph database 60, and a statistics database 70. The telemetry engine may generate various telemetry reports 80 that are stored in memory or other repositories for use.

In some examples, the various databases may be connected to multiple databases, such as the configuration database 50, the graph database 60, and the statistics database 70, which may be configured with one or more data centers that may be physical facilities or buildings located across geographic areas that are designated to store networked devices that are part of the networked environment (SDWAN cloud 10). The data centers may include various networking devices, as well as redundant or backup components and infrastructure for power supply, data communications connections, environmental controls, and various security devices. In some examples, the data centers may include one or more virtual data centers, which are a pool or collection of cloud infrastructure resources specifically designed for enterprise needs and/or for cloud-based service provider needs. Generally, the data centers (physical and/or virtual) may provide basic resources such as processor (CPU), memory (RAM), storage (disk), and networking (bandwidth). However, in some examples, the devices in the networked environment may not be located in explicitly defined data centers and, instead, may be located in other locations or buildings.

In some examples, the networked environment (CX cloud 20, SDWAN cloud services 10) may be a content delivery network (CDN), a scalable application service platform (e.g., an application orchestration system, such as Kubernetes), or other cloud-delivered networks. The networked environment may be accessible to one or more client devices over one or more networks. The networked environment and other networks may each respectively include one or more networks implemented by any viable communication technology, such as wired and/or wireless modalities and/or technologies. The networked environment and over networks may each include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.), Virtual Private Networks (VPNs), Wide Area Networks (WANs)—both centralized and/or distributed—and/or any combination, permutation, and/or aggregation thereof. The networked environment and/or other networks may include devices, virtual resources, or other nodes that relay packets from one network segment to another by nodes in the computer network.

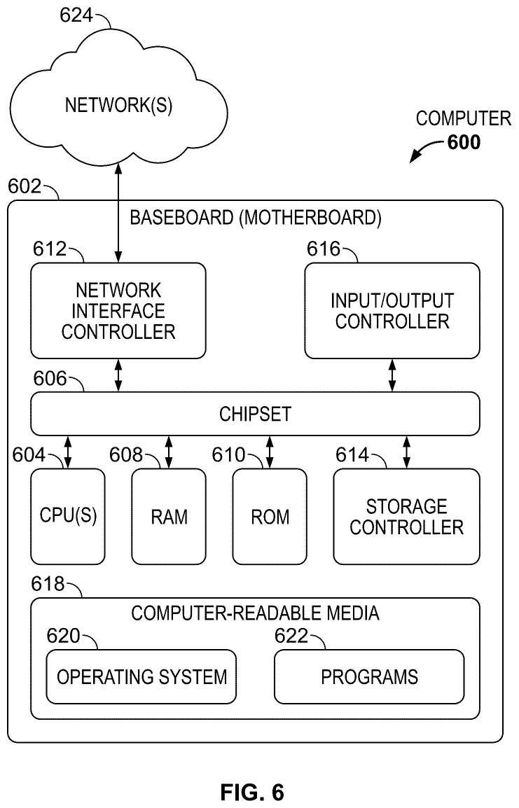

In some examples, the networked environment may provide, host, provide connectivity to, or otherwise support one or more services and/or applications for the client devices (See FIG. 6) to connect to and use. The client devices may comprise any device configured to communicate using various communication protocols (e.g., VPN, SSL, TLS, DTLS, and/or any other protocol) over the networks. For instance, the client device may comprise a personal user device (e.g., desktop computers, laptop computers, phones, tablets, wearable devices, entertainment devices such as televisions, etc.), network devices (e.g., servers, routers, switches, access points, etc.), and/or any other type of computing device.

In some examples, as shown in FIG. 1, the telemetry engine 40 fetches (1) a rule set either periodically or event-driven and proceeds to process (2) on-demand the rule set. Each rule set contains information that enables the SDWAN manager 30 to identify if a customer or third-party network device is implementing a set of configurations. However, the request based on the rule set is sent to the controller in the management plane that stores the data of device configuration without actually having to send the request to the endpoint device, saving processing and expediting real-time status results. Once the telemetry data is collected (3) by the telemetry engine 40, it is stored in various databases, including the configuration database 50, the graph database 60, and the statistical database 70, for further processing and comparisons. Also, the saved (4) telemetry data is further used in report generation to export (5) the telemetry data to the CX cloud 20 for customer review and business decision-making.

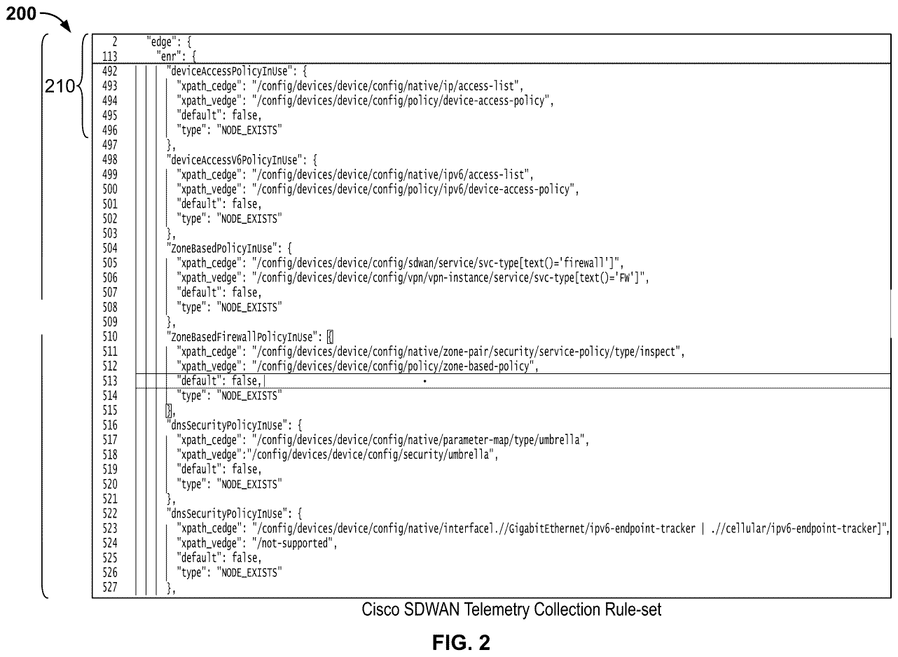

FIG. 2 collectively illustrates an example rule set for the SDWAN data collection of the telemetry system shown in FIG. 1 according to some examples. The example rule-set 200 shown in FIG. 2 is described herein in conjunction with the components of an example architecture 100, including the telemetry engine 40 of FIG. 1. In some examples, as shown in FIG. 2, the rule-set 200 using a particular rule-set 220 with a language (schema) 210 that is defined so the telemetry engine 40 can accurately interpret instructions for new query generation. Because any new rules introduced via the CX cloud 20 adhere to this same schema, the telemetry engine 40 can seamlessly generate on-demand telemetry data. The telemetry data that is generated and processed by the telemetry engine 40 is then exportable to a variety of collectors, such as CX Cloud (or MICROSOFT® Power Business Intelligence data visualization platform), enabling a customer to gather rich and diverse telemetry insights from its overlays without requiring upgrades to the controllers and devices (i.e., in this case, an upgrade is not necessary for the CISCO® vManage). This flexible approach allows the customer or the vendor to configure its products more effectively while also offering a way to quickly identify security issues and address any problems within its overlays when needed.

In some examples, to maintain privacy and security, the SDWAN manager 30 is configured not to need to or be required to export the entire data stored in the various databases (e.g., the configuration 50, the graph database 60, and the statistical database 70). For example, not all of the configuration items (CLs) need to be exported to the CX cloud 20. This prevents the disclosure or inadvertent dissemination of an entire database of proprietary information or sensitive customer information directly for telemetry purposes (particularly in a multi-vendor environment in use). The result is that the flexible configuration of the telemetry engine 40 assists in the information collection without the disclosure of proprietary information about a particular customer.

In some examples, the flexible approach to configuring the telemetry engine 40 also extends to the rule-set 200 configured in FIG. 2. For example, product managers or other users may define the CLI/xpath configurations that constitute a specific feature, then request that the telemetry data be collected accordingly (for example, if CLIs A, B, and C are present, feature ‘X’ is included in the telemetry output). In other words, instead of having a user need to embed these rules directly into the controller code (i.e., vManage code). With this approach, the rules can now be authored by the user in the cloud (CX cloud 20) and maintained in the CX cloud 20, allowing SDWAN users and customers, TMEs, product managers, and solution-based users to make contributions to the rule-sets being processed without needing access to the SDWAN controller's codebase. Since the SDWAN controller contains multiple databases—such as the configuration database that holds the device configurations across the overlay—many rules do not require accessing as they are directed to checking whether particular CLIs exist to determine which telemetry data is to be exported to the CX cloud 20 (for instance, if “bgp” CLIs appear in edge devices, it indicates BGP routing, while “eigrp” CLIs indicate EIGRP). Thus, enabling rule creation in the cloud makes writing and updating the telemetry rules for data collection more convenient and accessible to a broader range of stakeholders or users.

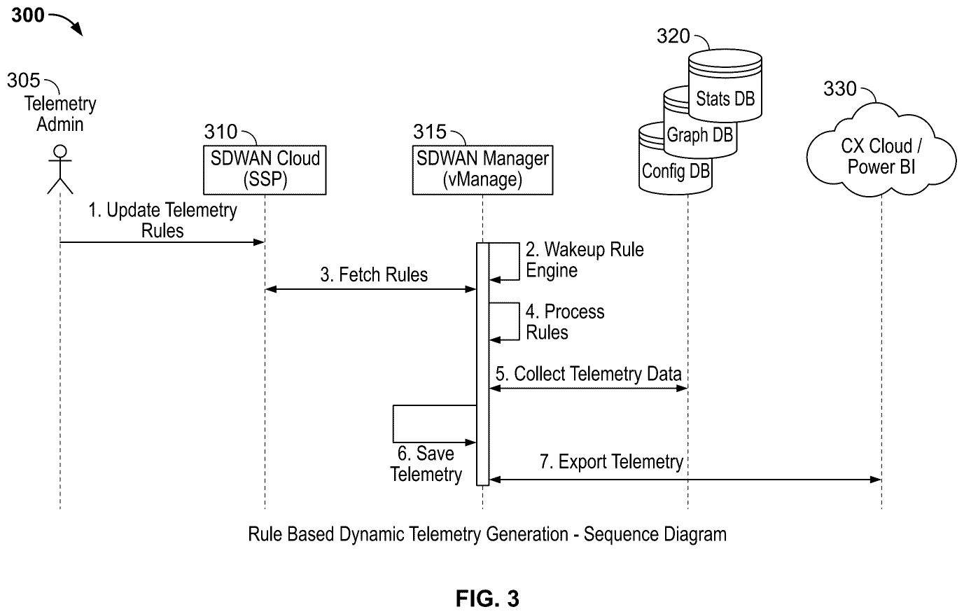

FIG. 3 illustrates a rule based dynamic telemetry generation sequence flow of FIG. 1 according to some examples. FIG. 3 shows method 300 of a rule-based telemetry flow diagram associated with some of the various technologies described herein. The operations described herein with respect to FIG. 3 may be implemented (1) as a sequence of computer-implemented acts or program modules running on a computing system and/or (2) as interconnected machine logic circuits or circuit modules within a computing system.

The implementation of the various components described herein is a matter of choice dependent on the performance and other requirements of the computing system. Accordingly, the operations described herein are referred to variously as operations, structural devices, acts, or modules. These operations, structural devices, acts, and modules can be implemented in software, in firmware, in special-purpose digital logic, and any combination thereof. It should also be appreciated that more or fewer operations might be performed than shown in the FIG. 3 described herein. These operations can also be performed in parallel or a different order than those described herein. Some or all of these operations can also be performed by components other than those specifically identified. Although the techniques described in this disclosure are with reference to specific components, in other examples, the techniques may be implemented by fewer components, more components, different components, or any configuration of components.

FIG. 3 is a rule-based flow diagram illustrating an example method 300 for collecting and processing data by the telemetry engine 40 of FIG. 1 according to some embodiments. Method 300 begins at operation (1) of updating the telemetry rules from a telemetry administrator 305, where the updated rules are sent to SDWAN cloud 310. In some examples, the updated rule set is independently configured without requiring permissions of the SDWAN controller codebase.

The telemetry engine 40 is configured in the management plane of the SDWAN manager 315 (vManage). It is configured to “wake up” (2) periodically or as desired, for example, to wake up every “X” hours/minutes to initiate a telemetry data collection action. In some examples, the telemetry engine 40 determines some or all of the features and/or metrics that are requested in these rules. In an example, the telemetry engine 40 is configured to be in a stateless mode. It is not configured to recall previous or prior features and related data that has been collected at an earlier cycle or interval. The telemetry engine 40 is configured to determine during operations or between one or more collection intervals if there are new feature data collection rules or updated rule sets that are applicable or have been added at the CX cloud or other connected clouds, then to initiate data collection operations based on those new rules or updated rule sets. For example, if the telemetry engine is awakened, it is configured to proceed with data collection based on the new or updated rule sets as needed.

In an instance, upon a wakeup action, the SDWAN manager 315 decides whether or not to fetch (3) a rule set or to update a rule set from the SDWAN cloud services 10. For example, the SDWAN manager 315 may process (4) a rule set that is scripted in a language that the telemetry engine 40 can interpret and collect (5) new telemetry data on demand for sending and/or receiving with various databases 320. The telemetry data is then stored or saved (6) and made exportable (7) to a variety of collectors 330 such as the CX cloud or the MICROSOFT® Power Business Intelligence data visualization platform.

In some examples, the telemetry engine 40 provides the following benefits not requiring network upgrades. By adding new rules on-demand in the cloud, the telemetry engine 40 is configured to collect additional telemetry from existing customer deployments immediately. The telemetry engine 40 interprets these new rules to generate additional metrics within current overlays, eliminating the need for any upgrades to the controller software or edge device software. The telemetry engine 40 provides fewer delays in data collection since upgrades to the network software are not needed, and the telemetry engine 40 can initiate data collection immediately across the managed WAN network, reducing time to obtain customer insight or other data about the network operations.

In some examples, the telemetry engine 40 maintains privacy because only targeted telemetry rules are updated in the cloud; there is no requirement to export entire customer configurations—which may contain sensitive or personally identifiable information—to external systems. This way, the system can enrich the telemetry data without exposing complete configurations stored in the management plane.

In some examples, the telemetry engine 40 provides enhancements in security with dynamic configuration telemetry that enables identifying security gaps in the customer overlay. For example, security is improved because of the exclusion of security gaps caused by outdated SSH algorithms, lack of NTP servers, or missing security policies. Based on these findings, a customer or vendor can proactively deliver security advisories to affected customers, helping them address vulnerabilities before they escalate.

In some examples, the telemetry engine 40 provides enhanced compliance enforcement by automating and continuously verifying network configurations against industry regulations (e.g., HIPAA, GDPR) and internal standards. This reduces audit preparation time and lowers the risk of non-compliance penalties. Since telemetry collection can be updated in real-time via new rules, it can be configured to adapt to evolving regulations or standards quickly.

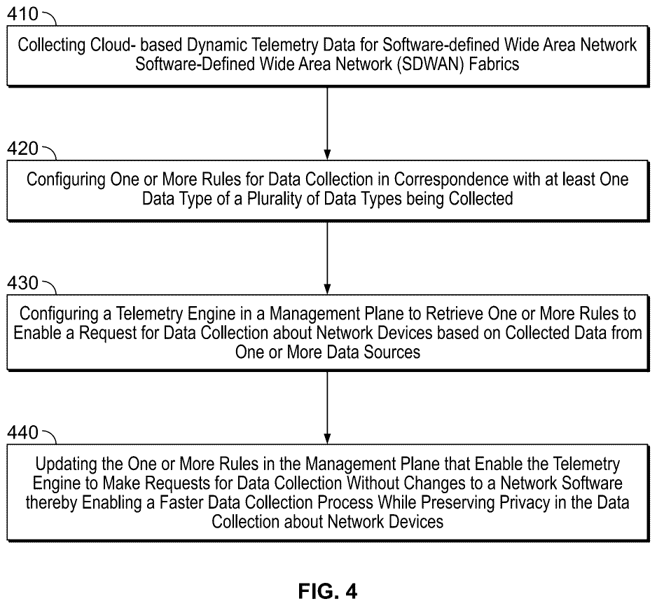

FIG. 4 illustrates a flow diagram of an example method associated with data collection by the telemetry engine routing control-plane traffic and data-plane traffic related to a common application. The method for telemetry data collection begins at operation 410, which includes collecting cloud-based dynamic telemetry data for software-defined wide area network Software-Defined Wide Area Network (SDWAN) fabrics. In some examples, the telemetry engine 40 is configured to change the frequency of data collection, and also for the types of information collected.

At operation 420, the telemetry engine 40 enables the configuring of one or more rules for data collection in correspondence with a plurality of the types of data being configured. It is configured to allow for telemetry collection by linking to and collecting data from different databases (or sources) for configuring a set of rules for data collection in the management plane and for saving the collected data in files and enabling, by a telemetry engine, to retrieve rules from the cloud or other external sources that a user independently configures. The telemetry engine 40 also enables dynamic rule updates without requiring changes to the network software, resulting in faster collection and preserved privacy.

At operation 430, the telemetry engine 40 retrieves the rule sets to enable or initiate a mode to make requests for data collection to various network controllers about the status of the network device (i.e., receive insights about the network operations) based on the data contained rules and the collected data from various data sources and independently scripted rules. For example, the telemetry engine processes any rule on demand by downloading a rule-set from the SD-WAN cloud (SSP-self-service portal), and the telemetry engine uses the processed downloaded rules to generate telemetry data, which are exported to different collectors (such as Customer Experience Cloud (CX) cloud). The telemetry engine 40 downloads the different rule-sets based on the various types of supporting databases and may query one or more databases to generate the telemetry data. In instances, the telemetry engine generates new queries on demand based on the information contained in the rule-set, and every controller connected to the SD-WAN cloud is also able to download these rule-sets periodically.

At operation 440, the telemetry engine is configured to make requests for data collection without changes to network software, thereby enabling a faster data collection process while preserving privacy in the data collection about network devices and the customer proprietary data such as configuration files and statistical data about network performance. The user-configured rules are written in JavaScript Object Notation (JSON) scripts, stored remotely in the cloud, and downloaded by the telemetry engine 40 in a management plane for execution, preventing sharing of the controller code. This allows the product managers (or engineers) to write the rules without requiring permissions of the SD-WAN manager codebase, outside of the controller in the cloud by other roles apart from just SD-WAN engineers (such as Technical Marketing Engineers (TMEs), solution engineers) and configuring a feedback loop between a telemetry collection system and an advisory system to allow for automatic security advisories to be sent. In some examples, the telemetry engine or the controller in the management plane may use the same mechanism (i.e., feedback loop) to send compliance-related advisories based on collected telemetry data. In some instances, the advisories may enable a more flexible and dynamic telemetry collection engine for SD-WAN.

In some examples, the dynamic telemetry collection engine allows the vendors to collect data or information about all existing and new SD-WAN overlays on demand without needing to upgrade or configure anything extra on controllers or edge devices. In some instances, the dynamic telemetry collection engine identifies security issues and gaps in existing customer overlays via telemetry collection. In some instances, the dynamic telemetry collection engine eliminates the need for controller device upgrades for collecting new metrics by introducing a new ‘telemetry (rule) engine’ in the controllers rather than static information and pairing it with an SD-WAN cloud. The updated ‘telemetry (rule) engine’ allows the vendors to update these rule-sets dynamically as needed without having to upgrade the controllers (i.e., this may assist vendors in collecting more SD-WAN telemetry on demand). In some instances, new or updated rules added by vendors via the cloud may adhere to the same language of the rule-set so that the telemetry engine interprets them and generates new telemetry data on demand;

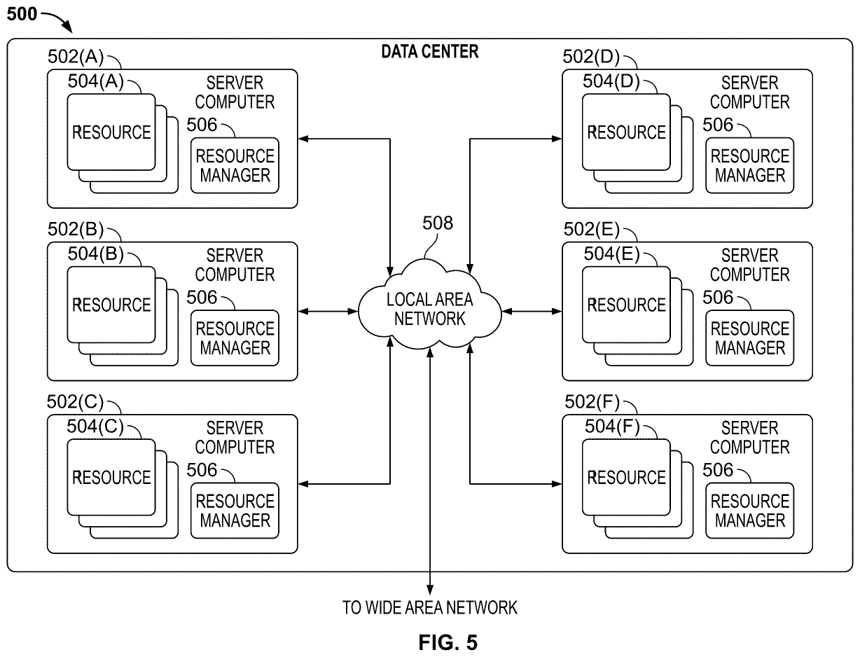

FIG. 5 is a computing system diagram illustrating an example configuration of a data center 500 that can be utilized to implement aspects of the technologies disclosed herein. The example data center 500 shown in FIG. 5 includes several server computers 502A-502F (which might be referred to herein singularly as “a server computer 502″ or in the plural as ”the server computers 502″) for providing computing resources. In some examples, the resources and/or server computers 502 may include or correspond to any management plane controller described herein. Although described as servers, server computers 502 may comprise any networked devices, such as servers, switches, routers, hubs, bridges, gateways, modems, repeaters, access points, etc.

The server computer 502 can be a standard tower, rack-mount, or blade server computer configured appropriately for providing computing resources. In some examples, the server computers 502 may provide computing resources 504, including data processing resources such as VM instances or hardware computing systems, database clusters, computing clusters, storage clusters, data storage resources, database resources, networking resources, security, packet inspection, and others. Some of the servers 502 can also be configured to execute a resource manager 506 capable of instantiating and/or managing the computing resources. In the case of VM instances, for example, the resource manager 506 can be a hypervisor or another type of program configured to enable the execution of multiple VM instances on a single server computer 502. Server computer 502 in the data center 500 can also be configured to provide network services and other types of services.

In the example, data center 500 shown in FIG. 5, an appropriate local area network (LAN) 508 is also utilized to interconnect the server computers 502A-502F. It should be appreciated that the configuration and network topology described herein have been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 500, between each of the server computers 502A-502F in each data center 500, and, potentially, between computing resources in each of the server computers 502. It should be appreciated that the configuration of the data center 500 described with reference to FIG. 5 is merely illustrative and that other implementations can be utilized.

In some examples, the server computers 502 may each execute one or more application containers and/or virtual machines to perform techniques described herein. In some instances, the data center 500 may provide computing resources, like application containers, VM instances, and storage, on a permanent or as-needed basis. Among other types of functionality, the computing resources provided by a cloud computing network may be utilized to implement the various services and techniques described above. The computing resources 504 provided by the cloud computing network can include multiple types of computing resources, such as data processing resources like application containers and VM instances, data storage resources, networking resources, data communication resources, network services, and the like.

Each type of computing resource 504 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 504 not explicitly mentioned herein.

The computing resources 504 provided by a cloud computing network may be enabled in one embodiment by one or more data centers 500 (which might be referred to herein singularly as “a data center 500” or in the plural as “the data centers 500”). The data centers 500 are facilities utilized to house and operate computer systems and associated components. The data centers 500 typically include redundant and backup power, communications, cooling, and security systems. The data centers 500 can also be located in geographically disparate locations. One illustrative embodiment for a data center 500 that can be utilized to implement the technologies disclosed herein will be described below with regard to FIG. 6.

FIG. 6 illustrates a schematic view of an example computer-hardware architecture for implementing a telemetry engine in a management plane with a controller, etc., that can be utilized to implement aspects of the various technologies presented herein. The computer architecture shown in FIG. 6 illustrates a conventional server computer, network device, workstation, desktop computer, laptop, tablet, network appliance, e-reader, smartphone, and/or another computing device. It can be utilized to execute any of the software components presented herein. The computer 600 may comprise networked devices such as servers, switches, routers, hubs, bridges, gateways, modems, repeaters, access points, etc.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPU 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to start up the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as network(s) 108 and/or network(s) 624. The chipset 606 can include functionality for providing network connectivity through a NIC 612, such as a gigabit Ethernet adapter. The NIC 612 is capable of connecting the computer 600 to other computing devices over the network. It should be appreciated that multiple NICs 612 can be present in the computer 600, connecting the computer to different types of networks and remote computer systems. In some examples, the NIC 612 may be configured to perform at least some of the techniques described herein and may include components for performing the techniques described herein.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of the physical state can depend on various factors in different embodiments of this description. Examples of such factors can include but are not limited to, the technology used to implement the physical storage units, whether the storage device 618 is characterized as primary or secondary storage, and the like.

For example, computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data, and that can be accessed by the computer 600. In some examples, the operations performed by the Architecture 100 and or any components included therein may be supported by one or more devices similar to Computer 600. Stated otherwise, some or all of the operations performed by the architecture 100, and or any components included therein, may be performed by one or more computer devices 600 operating in a cloud-based arrangement.

By way of example, and not limitation, computer-readable storage media can include volatile and non-volatile, removable and non-removable media implemented in any method or technology. Computer-readable storage media includes but is not limited to RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT® Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPU 604 transitions between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of the controller and other devices used in the telemetry data collection and the like. The computer 600 may include one or more hardware processors 604 (processors) configured to execute one or more stored instructions. The processor(s) 604 may comprise one or more cores. Further, the computer 600 may include one or more network interfaces (e.g., NIC 612) configured to provide communications between the computer 600 and other devices over a network, such as networks 108 and 624. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

Programs 622 may comprise any program or process to perform the techniques described in this disclosure for using computer networking protocol extensions (e.g., SNI, ECH, etc.) as a mechanism for collecting telemetry data from a management plane via a controller and for generating rule sets for processing by the telemetry engine.

### Example Clauses

Clause 1. A method comprising: collecting cloud-based dynamic telemetry data for software-defined wide area network Software-Defined Wide Area Network (SD-WAN) fabrics; configuring one or more rules for data collection in correspondence with at least one data type of a plurality of data types being collected; configuring a telemetry engine in a management plane to retrieve one or more rules to enable a request for data collection about network devices based on collected data from one or more data sources and updating the one or more rules in the management plane that enable the telemetry engine to make requests for data collection without changes to a network software, thereby enabling a faster data collection process while preserving privacy in the data collection about network devices.

Clause 2. The method of clause 1, further comprising: configuring the telemetry engine to retrieve one or more rules for data collection from a network cloud wherein the one or more rules have been independently configured for the data collection.

Clause 3. The method of clause 2, further comprising: configuring the telemetry engine to download one or more rules on demand from the SD-WAN fabrics to generate telemetry data for exporting to other data collection devices.

Clause 4. The method of clause 3, further comprising: configuring the telemetry engine in the management plane to query an appropriate database to generate telemetry data.

Clause 5. The method of clause 4, wherein the telemetry engine is configured to query the appropriate database on demand based on data contained in one or more rules.

Clause 6. The method of clause 5, further comprising configuring a controller in operable communication with the telemetry engine to download one or more rules discoverable at the telemetry engine on demand or periodically for processing one or requests associated with the one or more rules by the controller.

Clause 7. The method of clause 1, further comprising configuring the telemetry engine in the management plane for changing to a new metric associated with data collection without making network device changes for data collection based on the new metric.

Clause 8. The method of clause 1, further comprising configuring the telemetry engine in the management plane to change at least one of a frequency of data collection or a type of data being collected.

Clause 9. The method of clause 1, further comprising configuring the telemetry engine in the management plane to receive updates of one or more rules that have been independently updated by third parties in operable communication via a network cloud.

Clause 10. A system comprising: one or more processors; and one or more non-transitory computer-readable media storing instructions that, when executed by the one or more processors, cause the system to perform operations comprising: collecting cloud-based dynamic telemetry data for software-defined wide area network Software-Defined Wide Area Network (SD-WAN) fabrics; configuring one or more rules for data collection in correspondence with at least one data type of a plurality of data types being collected; configuring a telemetry engine in a management plane to retrieve one or more rules to enable a request for data collection about network devices based on collected data from one or more data sources; and updating the one or more rules in the management plane that enable the telemetry engine to make requests for data collection without changes to a network software thereby enabling a faster data collection process while preserving privacy in the data collection about network devices.

Clause 11. The system of clause 10, the operations further comprising configuring the telemetry engine to retrieve one or more rules for data collection from a network cloud wherein the one or more rules have been independently configured for the data collection.

Clause 12. The system of clause 11, the operations further comprising configuring the telemetry engine to download one or more rules on demand from the SD-WAN fabrics to generate telemetry data for exporting to other data collection devices.

Clause 13. The system of clause 12, the operations further comprising configuring the telemetry engine in the management plane to query an appropriate database to generate telemetry data.

Clause 14. The system of clause 13, wherein the telemetry engine is configured to query the appropriate database on demand based on data contained in one or more rules.

Clause 15. The system of clause 14, the operations further comprising configuring a controller in operable communication with the telemetry engine to download one or more rules discoverable at the telemetry engine on demand or periodically one or requests associated with the one or more rules by the controller.

Clause 16. The system of clause 11, the operations further comprising configuring the telemetry engine in the management plane for changing to a new metric associated with data collection without making network device changes for data collection based on the new metric.

Clause 17. The system of clause 11, the operations further comprising configuring the telemetry engine in the management plane to change at least one of a frequency of data collection or a type of data being collected.

Clause 18. The system of clause 11, the operations further comprising configuring the telemetry engine in the management plane to receive updates of one or more rules that have been independently updated by third parties in operable communication with the network cloud.

Clause 19. One or more non-transitory computer-readable media storing instructions that, when executed by one or more processors, cause the one or more processors to perform operations comprising: collecting cloud-based dynamic telemetry data for software-defined wide area network Software-Defined Wide Area Network (SD-WAN) fabrics; configuring one or more rules for data collection in correspondence with at least one data type of a plurality of data types being collected; configuring a telemetry engine in a management plane to retrieve one or more rules to enable a request for data collection about network devices based on collected data from one or more data sources; and updating the one or more rules in the management plane that enable the telemetry engine to make requests for data collection without changes to a network software thereby enabling a faster data collection process while preserving privacy in the data collection about network devices.

Clause 20. The one or more non-transitory computer-readable media of clause 19, the operations further comprising: configuring the telemetry engine to retrieve one or more rules for data collection from a network cloud wherein the one or more rules have been independently configured for the data collection wherein the telemetry engine is configured to query an appropriate database on demand based on data contained in one or more rules.

While the invention is described with respect to the specific examples, it is to be understood that the scope of the invention is not limited to these specific examples. For instance, while many of the examples are described with respect to IPsec protocols, it should be understood that the techniques described are applicable to other protocols. Since other modifications and changes varied to fit particular operating requirements and environments will be apparent to those skilled in the art, the invention is not considered limited to the example chosen for purposes of disclosure and covers all changes and modifications that do not constitute departures from the true spirit and scope of this invention.

Although the application describes embodiments having specific structural features and/or methodological acts, it is to be understood that the claims are not necessarily limited to the specific features or acts described. Instead, the specific features and acts are merely illustrative of some embodiments that fall within the scope of the claims of the application.

What is claimed is:

1. A method comprising:
collecting cloud-based dynamic telemetry data for software-defined wide area network Software-Defined Wide Area Network (SD-WAN) fabrics;
configuring one or more rules for data collection in correspondence with at least one data type of a plurality of data types being collected;
configuring a telemetry engine in a management plane to retrieve one or more rules to enable a request for data collection about network devices based on collected data from one or more data sources and
updating the one or more rules in the management plane that enable the telemetry engine to make requests for data collection without changes to a network software, thereby enabling a faster data collection process while preserving privacy in the data collection about network devices.

2. The method of claim 1, further comprising:
configuring the telemetry engine to retrieve one or more rules for data collection from a network cloud wherein the one or more rules have been independently configured for the data collection.

3. The method of claim 2, further comprising:
configuring the telemetry engine to download one or more rules on demand from the SD-WAN fabrics to generate telemetry data for exporting to other data collection devices.

4. The method of claim 3, further comprising: configuring the telemetry engine in the management plane to query an appropriate database to generate telemetry data.

5. The method of claim 4, wherein the telemetry engine is configured to query the appropriate database on demand based on data contained in one or more rules.

6. The method of claim 5, further comprising configuring a controller in operable communication with the telemetry engine to download one or more rules discoverable at the telemetry engine on demand or periodically for processing one or requests associated with the one or more rules by the controller.

7. The method of claim 1, further comprising configuring the telemetry engine in the management plane for changing to a new metric associated with data collection without making network device changes for data collection based on the new metric.

8. The method of claim 1, further comprising configuring the telemetry engine in the management plane to change at least one of a frequency of data collection or a type of data being collected.

9. The method of claim 1, further comprising configuring the telemetry engine in the management plane to receive updates of one or more rules that have been independently updated by third parties in operable communication via a network cloud.

10. A system comprising:
one or more processors; and
one or more non-transitory computer-readable media storing instructions that, when executed by the one or more processors, cause the system to perform operations comprising:
collecting cloud-based dynamic telemetry data for software-defined wide area network Software-Defined Wide Area Network (SD-WAN) fabrics;
configuring one or more rules for data collection in correspondence with at least one data type of a plurality of data types being collected;
configuring a telemetry engine in a management plane to retrieve one or more rules to enable a request for data collection about network devices based on collected data from one or more data sources; and
updating the one or more rules in the management plane that enable the telemetry engine to make requests for data collection without changes to a network software thereby enabling a faster data collection process while preserving privacy in the data collection about network devices.

11. The system of claim 10, the operations further comprising configuring the telemetry engine to retrieve one or more rules for data collection from a network cloud wherein the one or more rules have been independently configured for the data collection.

12. The system of claim 11, the operations further comprising configuring the telemetry engine to download one or more rules on demand from the SD-WAN fabrics to generate telemetry data for exporting to other data collection devices.

13. The system of claim 12, the operations further comprising configuring the telemetry engine in the management plane to query an appropriate database to generate telemetry data.

14. The system of claim 13, wherein the telemetry engine is configured to query the appropriate database on demand based on data contained in one or more rules.

15. The system of claim 14, the operations further comprising configuring a controller in operable communication with the telemetry engine to download one or more rules discoverable at the telemetry engine on demand or periodically one or requests associated with the one or more rules by the controller.

16. The system of claim 11, the operations further comprising configuring the telemetry engine in the management plane for changing to a new metric associated with data collection without making network device changes for data collection based on the new metric.

17. The system of claim 11, the operations further comprising configuring the telemetry engine in the management plane to change at least one of a frequency of data collection or a type of data being collected.

18. The system of claim 11, the operations further comprising configuring the telemetry engine in the management plane to receive updates of one or more rules that have been independently updated by third parties in operable communication with the network cloud.

19. One or more non-transitory computer-readable media storing instructions that, when executed by one or more processors, cause the one or more processors to perform operations comprising:
collecting cloud-based dynamic telemetry data for software-defined wide area network Software-Defined Wide Area Network (SD-WAN) fabrics;
configuring one or more rules for data collection in correspondence with at least one data type of a plurality of data types being collected;
configuring a telemetry engine in a management plane to retrieve one or more rules to enable a request for data collection about network devices based on collected data from one or more data sources; and
updating the one or more rules in the management plane that enable the telemetry engine to make requests for data collection without changes to a network software thereby enabling a faster data collection process while preserving privacy in the data collection about network devices.

20. The one or more non-transitory computer-readable media of claim 19, the operations further comprising:
configuring the telemetry engine to retrieve one or more rules for data collection from a network cloud wherein the one or more rules have been independently configured for the data collection wherein the telemetry engine is configured to query an appropriate database on demand based on data contained in one or more rules.
